(19) United States
(12) Patent Application Publication
(10) Pub. No.: US 2026/0089653 A1
(43) Pub. Date: Mar. 26, 2026

(54) AUTOMATIC GAIN CONTROL IN A WIRELESS RECEIVER USING SATURATION DETECTION FROM MODEM SAMPLES

(71) Applicant: QUALCOMM Incorporated, San Diego, CA (US)

(72) Inventors: Manav LNU, Hyderabad (IN); Balasubramanian RAMACHANDRAN, Hyderabad (IN); Hemanth Kumar UMMADISETTY, Hyderabad (IN); Prakash THOPPAY EGAMBARAM, San Diego, CA (US)

(21) Appl. No.: 18/895,695

(22) Filed: Sep. 25, 2024

(51) Int. Cl. H04W 52/52; H04B 1/10; H04B 1/16; H04B 17/336

(52) U.S. Cl. CPC H04W 52/52; H04B 1/1027; H04B 1/16; H04B 17/336

(57) ABSTRACT

Methods and apparatus for performing automatic gain control in wireless receive front-end circuitry are described. An example apparatus includes control logic coupled to a receive chain. The control logic is configured to set a gain state of a portion of an analog front end (AFE) of the receive chain to a first gain state. In response to detecting an occurrence of a saturation condition at an output of the AFE portion, the control logic is configured to generate a logic signal to trigger a switch in the gain state from the first gain state to a second gain state. A combined gain of the AFE portion in the first gain state is greater than the combined gain in the second gain state. The combined gain of the AFE portion in the second gain state is a highest gain that ensures no saturation at the output of the AFE portion.

### BACKGROUND

### Field of the Disclosure

Aspects of the present disclosure relate to electronic circuits, and more particularly, to techniques for performing automatic gain control in wireless receive front-end circuitry.

### Description of Related Art

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include radio frequency front-end (RFFE) circuitry, which may be used for processing and amplifying signals for transmission and reception, for example.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include improved reference sensitivity of a receiver, as an illustrative example.

Certain aspects of the present disclosure provide an apparatus for wireless communications. The apparatus generally includes a receive chain configured to receive an analog reception signal and to process the analog reception signal to generate a digital reception signal. The apparatus also includes control logic having an input coupled to an output of the receive chain. The control logic is configured to set a gain state of a portion of an analog front end (AFE) of the receive chain to a first gain state of a plurality of gain states. The control logic is also configured to, while the gain state is the first gain state, detect an occurrence of a saturation condition at an output of the portion of the AFE based at least in part on the digital reception signal or a signal from the portion of the AFE indicating the occurrence of the saturation condition. The control logic is further configured to, in response to the detection, generate a first logic signal to trigger a switch in the gain state of the portion of the AFE from the first gain state to a second gain state of the plurality of gain states. A combined gain of the portion of the AFE when the gain state is the first gain state is greater than the combined gain of the portion of the AFE when the gain state is the second gain state. The combined gain of the portion of the AFE when the gain state is the second gain state is a highest gain that ensures no saturation at the output of the portion of the AFE.

Certain aspects of the present disclosure provide a method for wireless communications. The method generally includes setting a gain state of a portion of an analog front end (AFE) of a receive chain to a first gain state of a plurality of gain states. The method also includes, while the gain state is the first gain state, detecting an occurrence of a saturation condition at an output of the portion of the AFE based at least in part on a digital reception signal generated via the receive chain or a signal from the portion of the AFE indicating the occurrence of the saturation condition. The method further includes, in response to the detection, generating a logic signal to trigger a switch in the gain state of the portion of the AFE from the first gain state to a second gain state of the plurality of gain states. A combined gain of the portion of the AFE when the gain state is the first gain state is greater than the combined gain of the portion of the AFE when the gain state is the second gain state. The combined gain of the portion of the AFE when the gain state is the second gain state is a highest gain that ensures no saturation at the output of the portion of the AFE.

Certain aspects of the present disclosure provide a wireless device. The wireless device includes an antenna, a receive chain coupled to the antenna, and control logic having an input coupled to an output of the receive chain. The receive chain is configured to receive an analog reception signal via the antenna and to process the analog reception signal to generate a digital reception signal. The control logic is configured to set a gain state of a portion of an analog front end (AFE) of the receive chain to a first gain state of a plurality of gain states. The control logic is also configured to, while the gain state is the first gain state, detect an occurrence of a saturation condition at an output of the portion of the AFE based at least in part on the digital reception signal or a signal from the portion of the AFE indicating the occurrence of the saturation condition. The control logic is further configured to, in response to the detection, generate a logic signal to trigger a switch in the gain state of the portion of the AFE from the first gain state to a second gain state of the plurality of gain states. A combined gain of the portion of the AFE when the gain state is the first gain state is greater than the combined gain of the portion of the AFE when the gain state is the second gain state. The combined gain of the portion of the AFE when the gain state is the second gain state is a highest gain that ensures no saturation at the output of the portion of the AFE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 illustrates an example non-contiguous carrier aggregation scenario, according to certain aspects of the present disclosure.

FIG. 5 illustrates an example offset zero intermediate frequency operation for the non-contiguous carrier aggregation scenario depicted in FIG. 4, according to certain aspects of the present disclosure.

FIG. 6 illustrates an example split carrier aggregation (SCA) operation for the non-contiguous carrier aggregation scenario depicted in FIG. 4, according to certain aspects of the present disclosure.

FIG. 7 illustrates an example apparatus for performing receiver automatic gain control for a wireless receive path, according to certain aspects of the present disclosure.

FIG. 8 further illustrates an example modem of the apparatus depicted in FIG. 7, according to certain aspects of the present disclosure.

FIG. 9 is a state diagram for controlling a gain state of a portion of an analog front end of a receive path, according to certain aspects of the present disclosure.

FIG. 10 illustrates an example architecture of a neural network, according to certain aspects of the present disclosure.

FIG. 11 is a flow diagram of example operations for performing receiver automatic gain control for a receive path, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure generally relate to techniques and apparatus for performing automatic gain control (AGC) in wireless receive front-end circuitry.

Certain systems, such as 5G NR, may support carrier aggregation (CA), such as contiguous CA and non-contiguous CA. In contiguous CA, multiple available component carriers (CCs) are adjacent to each other. In non-contiguous CA, multiple available CCs are separated along a frequency band. Both non-contiguous and contiguous CA aggregate multiple CCs to serve a single wireless device, such as a user equipment (UE), as an illustrative example.

In some cases, a wireless device operating in a multicarrier system (e.g., a system supporting CA) can be configured to aggregate certain functions of multiple carriers, such as control and feedback functions, on a single carrier, which may be referred to as the primary component carrier (PCC). The remaining associated carriers that depend on the PCC for support may be referred to as the secondary component carriers (SCCs).

One potential challenge with operating in a multicarrier system is that there may be a low separation between the PCC within the transmit (TX) frequency band and the SCC within the receive (RX) frequency band (commonly referred to as a TX-RX gap) in certain CA scenarios (e.g., certain non-contiguous CA scenarios, such as n25 TX band+n25 RX band). This low TX-RX gap can lead to the receive (RX) chain of a wireless device being impacted by strong jamming signals, which may be caused, for example, by radio emissions in nearby bands, such as radio transmissions from the wireless device in the TX frequency band.

Moreover, low TX-RX gap scenarios can also be present in certain single carrier deployments. As an illustrative example, single carrier cases with small duplex gaps (e.g., n71 band with 35 MHz channel bandwidth, n12 band with 15 MHz channel bandwidth, etc.) may have low TX-RX gaps that can lead to the RX chain of a wireless device being impacted by strong jamming signals in the TX frequency band, for example.

In scenarios in which there is a low TX-RX gap, conventional wireless devices generally back off the gain of the internal low noise amplifier (LNA) (iLNA) and/or the transimpedance amplifier (TIA) (used to implement a baseband filter (BBF)) within the RX chain in order to avoid saturation at the TIA output in the presence of jamming signals. However, the gain backoff amount is determined based on multiple worst-case assumptions regarding conditions at the analog front end, such as single-ended swing at TIA output, duplexer isolation and external LNA (eLNA) gain, as illustrative, non-limiting examples. As used herein, an iLNA may refer to an LNA within an RF transceiver and an eLNA may refer to an LNA external to the RF transceiver. Additionally, the gain backoff can increase the receiver (RX) noise figure (NF), thereby degrading the reference sensitivity (refsens) performance of the receiver.

To address this, certain aspects of the present disclosure provide an improved receiver automatic gain control (RxAGC) algorithm (or RxAGC logic) for controlling the gain of one or more amplifiers within the RX chain of a wireless device. As described in greater detail below, the RxAGC algorithm described herein may employ a new gain state (referred to herein as G0′) in addition to a default gain state (referred to herein as G0). The new gain state G0′ may have a higher gain (and lower NF) than the default gain state G0. The default gain state G0 may be a gain state that ensures no saturation at the output of the TIA within the RX chain. That is, the combined gain of the iLNA /IA within the RX chain when the gain state is the default gain state G0 may be a highest gain that ensures no saturation at the output of the TIA within the RX chain.

In certain aspects, the RxAGC algorithm may initially control the combined gain of amplifier(s) within the RX chain of the wireless device based on the new gain state G0′. Compared to the default gain state G0, the new gain state G0′ may allow for some amount of saturation at the TIA output. However, at the same time, operating in the new gain state G0′ may cause unacceptable TIA saturation for certain band combinations/Rx paths, and therefore, operation in G0′ should be avoided in certain conditions.

Accordingly, in certain aspects, when the RxAGC algorithm detects that certain conditions are satisfied, the RxAGC algorithm may switch from controlling the combined gain of the amplifier(s) within the RX chain of the wireless device based on the new gain state G0′ to controlling the combined gain of the amplifier(s) based on the default gain state G0. In certain aspects, the conditions may include detecting an occurrence of a saturation condition at the output of the TIA within the RX chain. As described in greater detail below, in certain aspects, the RxAGC algorithm may employ a trained neural network to determine the occurrence of the saturation condition. For example, the neural network may be trained to detect saturation occurring at the output of the TIA based on evaluating one or more saturation signatures visible downstream in the RX chain (e.g., at the digital input to the modem). Alternatively, as described in greater detail below, in certain other aspects, the RxAGC algorithm may use one or more saturation detection circuits coupled to the RX chain (e.g., at the TIA output) to determine the occurrence of the saturation condition. For example, the saturation detection circuit(s) may detect saturation occurring at the TIA output by determining the power of the analog signal and comparing the power of the analog signal to a threshold.

The apparatus and techniques for performing AGC in wireless receive front-end circuitry may provide various technical advantages. For example, controlling the combined gain of the amplifier(s) within the RX chain of the wireless device based on the new gain state, which has a higher gain and lower NF than the default gain state, may improve the reference sensitivity of the wireless receiver, relative to conventional RxAGC algorithms. Consequently, by using the RxAGC algorithm described herein, the performance of wireless receivers (relative to conventional RxAGC algorithms) may be significantly improved in terms of higher throughput, reduced latency, and higher transmission range, as illustrative, non-limiting examples.

Note that, as used herein, the term “wireless receiver” may refer to the RX operations of a wireless transceiver, RX chain of a wireless transceiver, or RX path of a wireless transceiver. Accordingly, the terms “wireless receiver,” “RX operations of a wireless transceiver,” “RX path of a wireless transceiver,” and “RX chain of a wireless transceiver” may be used interchangeably.

Although the terms “first,” “second,” “third,” etc., may be used herein to describe various devices, elements, components, regions, layers and/or sections, these devices, elements, components, regions, layers and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

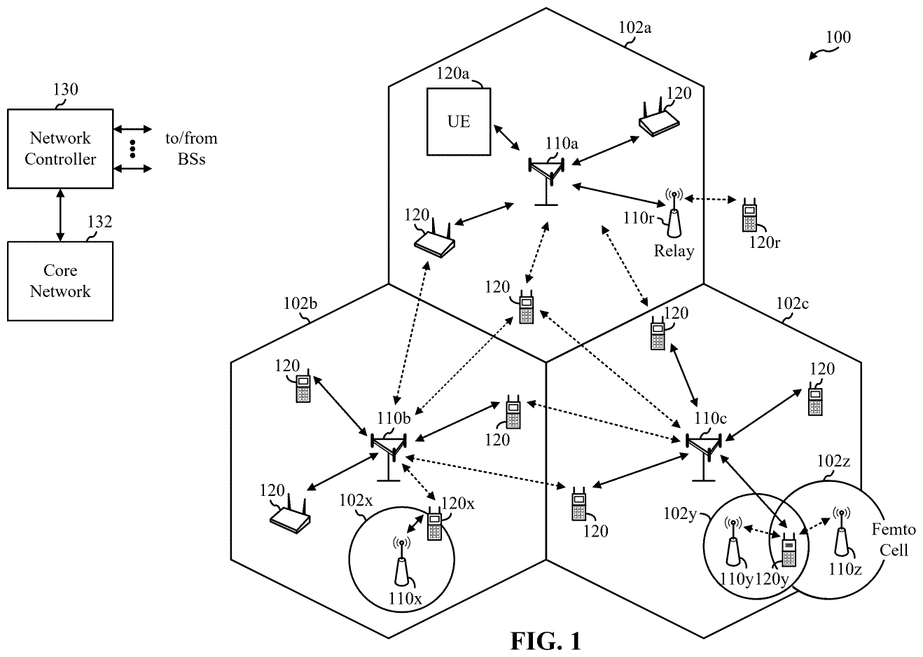

FIG. 1 illustrates an example wireless communications network 100, in which aspects of the present disclosure may be practiced. For example, the wireless communications network 100 may be a New Radio (NR) system (e.g., a Fifth Generation (5G) NR network), a Sixth Generation (6G) cellular system, an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an Institute of Electrical and Electronics Engineers (IEEE) standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may include a transceiver front end (TX/RX) (also known as a radio frequency front end (RFFE)). The RFFE may implement RxAGC using one or more techniques described herein.

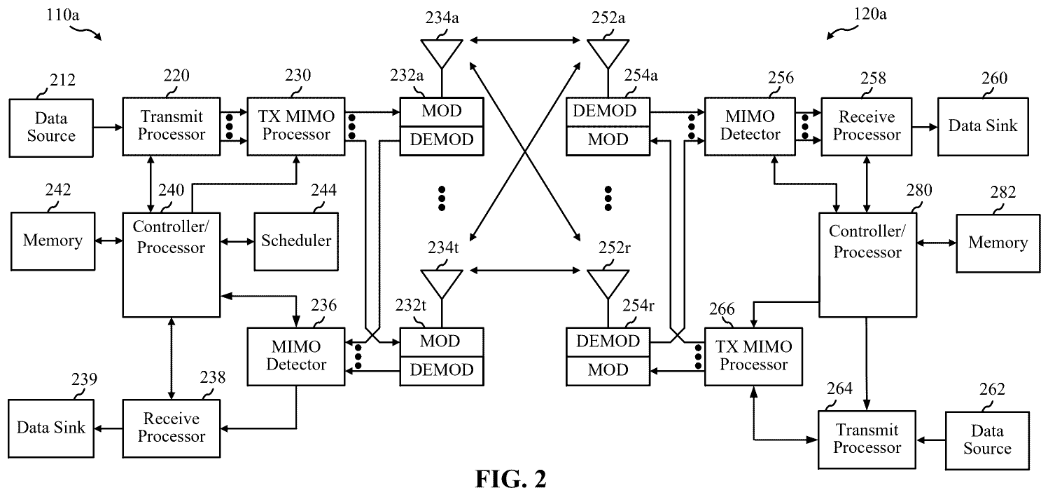

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH, demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

Antennas 252, processors 258, 264, 266, and/or controller/processor 280 of the UE 120a and/or antennas 234, processors 220, 230, 238, and/or controller/processor 240 of the BS 110a may be used to perform the various techniques and methods described herein.

In certain aspects of the present disclosure, the transceivers 232 and/or the transceivers 254 may include RF front-end circuitry that implements RxAGC using one or more techniques described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

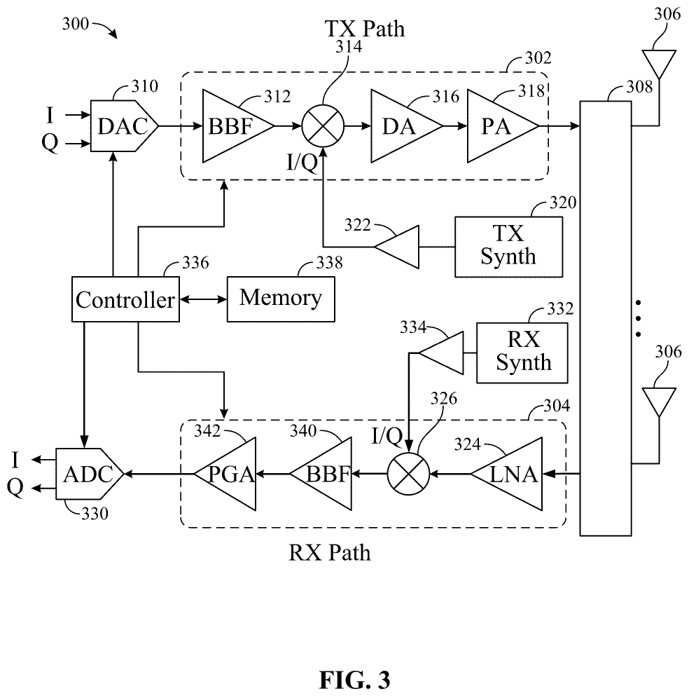

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit (TX) chain” or “transmit (TX) operations”) for transmitting signals via one or more antennas 306 and at least one receive (RX) path 304 (also known as a “receive (RX) chain” or “receive (RX) operations”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC. In such aspects, the RFIC (and thus the DA 316) may be coupled to the PA 318 over one or more interconnections, for example, a conductive line or cabling such as a coaxial cable or flex circuit.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, a baseband filter (BBF) 340, and a programmable gain amplifier (PGA) 342, and a baseband filter (BBF) 328. The LNA 324, the mixer 326, the BBF 340, and the PGA 342 may be included in one or more RFICs, which may or may not be the same RFIC that includes the TX path components. In such cases, the LNA 324 may be an iLNA. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328, and the filtered baseband signals output by the BBF 328 may be amplified by the PGA 342 before being converted by an analog-to-digital converter (ADC) 330 to digital I and/or Q signals for digital signal processing. For example, one or more modems (not shown) may receive the digital I or Q signals and further process the digital signals, for example, demodulating the digital signals. In certain aspects, the BBF 340 may be implemented with a transimpedance amplifier (TIA). In some cases, the PGA 342 may be a programmable baseband amplifier (PBA).

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency multiplier, such as a frequency doubler, that is driven by an oscillator (e.g., a VCO) in the frequency synthesizer.

A controller 336 (e.g., controller/processor 280 in FIG. 2) may direct the operation of the RF transceiver circuit 300, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for automatic gain control in any suitable device, electronic system, or other wireless communication system. For example, a wireless communication device may be implemented with a modem integrated circuit (IC), a transceiver IC, and a front-end module or a collection of front-end components. The modem IC may be part of a main system-on-chip (SoC) with an application processor, in some aspects. The modem IC may be coupled to the transceiver IC (e.g., a separate wireless local area network (WLAN) chip or a separate sub-6 GHz software-defined radio (SDR) chip). The transceiver IC may include baseband circuitry, mixers, and pre-amplifiers, for example. The transceiver IC may be coupled to the front-end module or components, which may include a PA.

Example Scenarios with Low TX-RX Gap

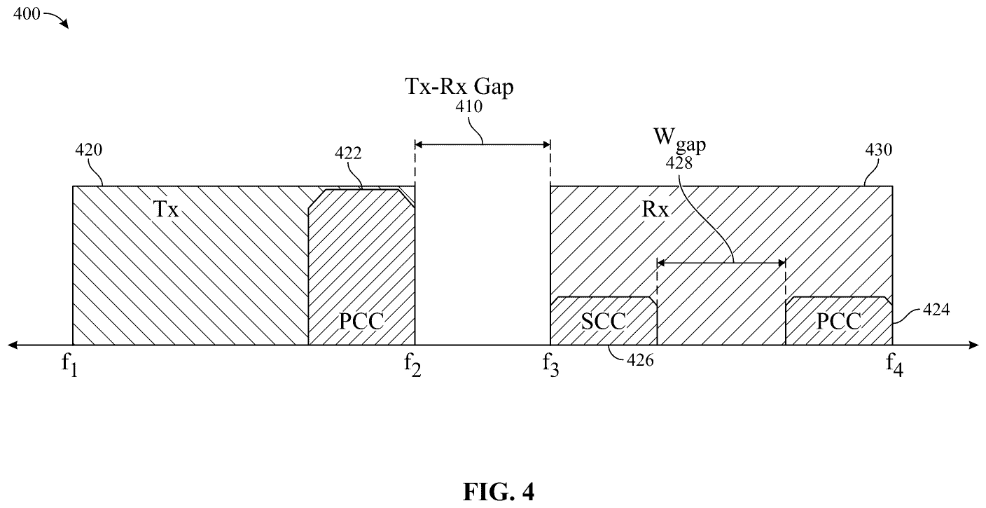

As noted, in certain scenarios, there may be a low frequency separation between the PCC within the TX frequency band and the SCC within the RX frequency band (commonly referred to as a TX-RX gap). Scenarios in which there is a low TX-RX gap may include certain non-contiguous CA scenarios. Consider FIG. 4 which illustrates a non-contiguous CA scenario 400, according to certain aspects of the present disclosure.

In the depicted non-contiguous CA scenario 400, the TX frequency band 420 includes a PCC 422, and the RX frequency band 430 includes a PCC 424 and a SCC 426. The TX frequency band 420 is located between f₁ and f₂, and the RX frequency band 430 is located between f₃ and f₄, where f₁<f₂<f₃<f₄. The parameter W_{gap} 428 is the frequency gap between the PCC 424 and SCC 426 within the RX frequency band 430 and may be configurable. The TX-RX gap 410 is the frequency separation between the PCC 422 within the TX frequency band 420 and the SCC 426 within the RX frequency band 430. The amount of the TX-RX gap 410 may be based on the W_{gap} 428. For example, larger values of W_{gap} 428 may reduce the TX-RX gap 410, and smaller values of W_{gap} 428 may increase the TX-RX gap 410.

In certain cases, a non-contiguous CA scenario (e.g., the non-contiguous CA scenario 400) may have a low TX-RX gap (e.g., TX-RX gap 410) when W_{gap} (e.g., W_{gap} 428) is larger than a threshold. By way of example, in the n25 band, n25 TX (5 MHz channel bandwidth)+n25 RX (5 MHz channel bandwidth) with W_{gap}=55 MHz may lead to a TX-RX gap approximately equal to 15 MHz. Such a low TX-RX gap can lead to the RX chain of a wireless device being impacted by strong jamming signals caused by radio emissions in the TX band, for example.

As also noted, certain single carrier scenarios may also have a low TX-RX gap. By way of example, the n71 band (35 MHz channel bandwidth) may have a TX-RX gap approximately equal to 15 MHz, and the n12 band (15 MHz channel bandwidth) may have a TX-RX gap approximately equal to 11 MHz. These low TX-RX gaps can also lead to the RX chain of a wireless device being impacted by strong jamming signals caused by radio emissions in the TX band, for example.

Additionally, in certain cases, wireless devices may support offset zero intermediate frequency (OZIF) operation and split carrier aggregation (SCA) operation. In OZIF operation, the PCC and SCC within the RX frequency band are generally treated as a single aggregate signal. In SCA operation, the PCC and SCC within the RX frequency band are generally treated as separate signals.

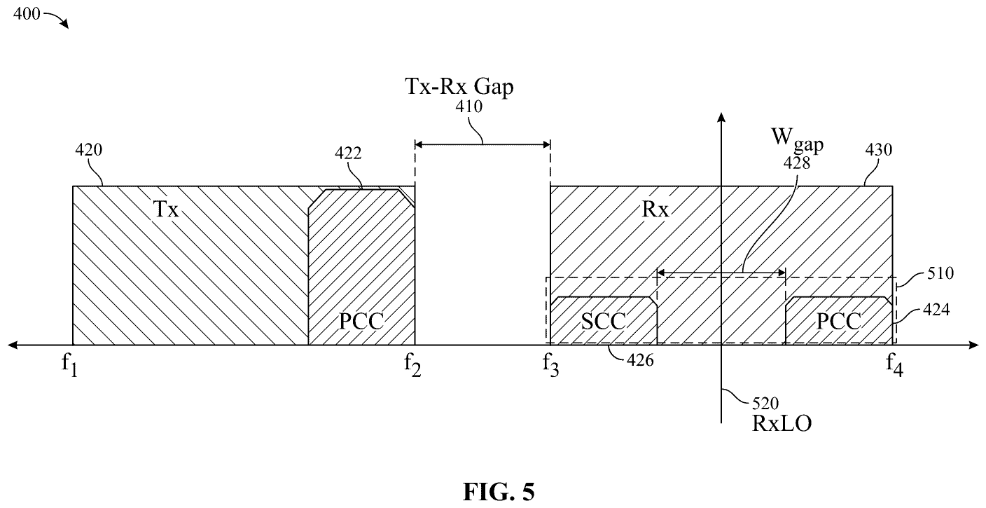

FIG. 5 illustrates an example OZIF operation for the non-contiguous CA scenario 400 illustrated in FIG. 4, according to certain aspects of the present disclosure. As shown in FIG. 5, the PCC 424 and SCC 426 are considered as a single aggregate signal 510 with a single receiver LO (RxLO) 520 placed at a middle frequency between the PCC 424 and SCC 426.

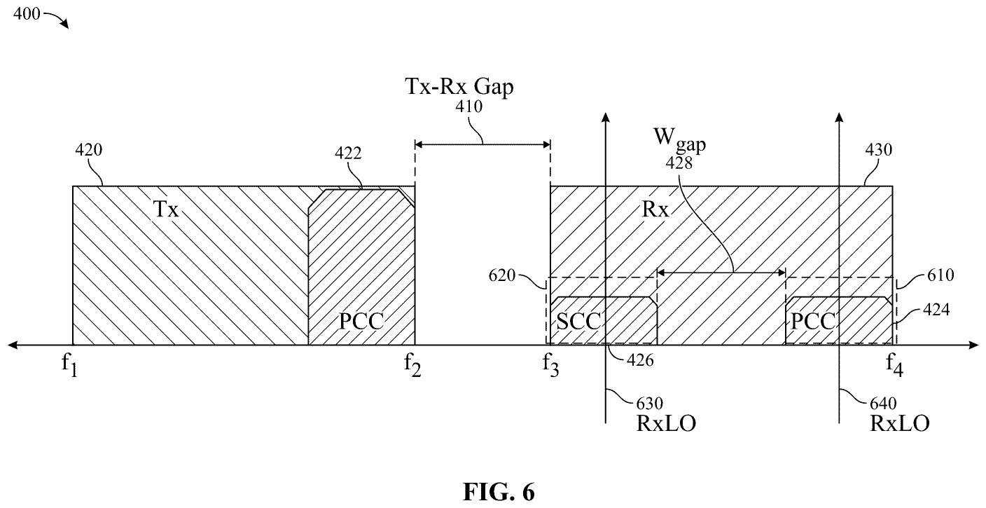

FIG. 6 illustrates an example SCA operation for the non-contiguous CA scenario 400 illustrated in FIG. 4, according to certain aspects of the present disclosure. As shown in FIG. 6, the PCC 424 is considered as a signal 610 with a RxLO 640 placed at a center of the PCC 424, and the SCC 426 is considered as a signal 620 with a RxLO 630 placed at a center of the SCC 426.

For non-contiguous CA scenarios, SCA operation may be preferred over OZIF operation since SCA may lead to a better SDR NF than OZIF. However, the availability of SCA operation may depend on whether there is a sufficient amount of resources within the wireless device. For example, in SCA, the iLNA may be shared between the PCC 424 and SCC 426, but separate RF chains (consisting of a mixer and BBF), ADCs, and digital receiver front end (RxFE) chains may be used for the PCC 424 and SCC 426. Due in part to the additional components for each component carrier, SCA operation may be sub-optimal in terms of power consumption compared to OZIF operation. Moreover, in SCA, the second-order inter-modulation (IM2) of transmitter (TX) leakage may overlap with the desired signal bandwidth. On the other hand, for OZIF, depending on W_{gap} and PCC/SCC bandwidths, the IM2 of the TX leakage may or may not overlap with the desired signal bandwidth.

In conventional wireless devices, TIA saturation caused by a TX jamming signal may not be detectable in OZIF scenarios with low TX-RX gaps. For example, jammer detection is generally based on wideband energy estimation (WBEE) in the digital RxFE, and the energy of the saturating TX jamming signal may be attenuated heavily by the PGA pole and WBEE pre-filter.

In OZIF scenarios with low TX-RX gaps, conventional wireless devices generally back off the iLNA+TIA gain to avoid saturation at the TIA output in the presence of a TX jamming signal. However, this gain backoff can lead to an increased RX NF, thereby degrading the refsens performance of the receiver. Furthermore, the gain backoff amount is generally determined based on multiple worst-case assumptions regarding conditions at the analog front end to ensure that no saturation occurs at the output of the TIA during receive operations.

One illustrative example worst-case assumption is that the single-ended swing at the TIA output=±0.45 volts (V), whereas a typical value of the single-ended swing at the TIA output may be approximately equal to ±0.5 V. In this example, assuming the typical value of the single-ended swing at the TIA output is used, the recoverable gain backoff may be approximately 0.9 dB.

Another illustrative example worst-case assumption is that the duplexer isolation is approximately equal to 55 dB, whereas the typical isolation can be approximately 5-10 dB higher. In this example, assuming the typical value of the duplexer isolation is used, the recoverable gain backoff may be a few dBs to several dBs.

Another illustrative example worst-case assumption is that the eLNA gain is approximately equal to 19 dB, whereas the typical eLNA gain may be approximately equal to 18 dB. In this example, assuming the typical value of the eLNA gain is used, the recoverable gain backoff may be approximately 1 dB.

Another illustrative example worst-case assumption that limits the iLNA gain is that the maximum transmit power is approximately equal to 24 dBm, whereas the actual transmit power may be a few dB lower due to maximum power reduction (MPR). Note that in cases where MPR is used to reduce the transmit power, the swing at the TIA output may be the same as when the maximum transmit power is used due to a proportional increase in peak-to-average power ratio (PAPR). In current wireless devices, the iLNA gain may be limited by the worst case assumption of the TX IM2 (disregarding the MPR).

### Example Automatic Gain Control in a Wireless Receiver Using Saturation Detection from Modem Samples

As noted, certain aspects provide an improved RxAGC algorithm for controlling the gain of one or more amplifiers (e.g., iLNA and TIA (used to implement the BBF)) within the RX chain of a wireless device. The RxAGC algorithm described herein may employ a new gain state (referred to herein as G0′) in addition to a default gain state (referred to herein as G0). The new gain state G0′ may have a higher gain (and lower NF) than the default gain state G0.

In certain aspects, the RxAGC algorithm may initially control the combined gain of amplifier(s) within the RX chain of the wireless device based on the new gain state G0′. When the RxAGC algorithm detects that certain conditions are satisfied, the RxAGC algorithm may switch from controlling the combined gain of the amplifier(s) based on the new gain state G0′ to controlling the combined gain of the amplifier(s) within the RX chain of the wireless device based on the default gain state G0. In certain aspects, the conditions may include detecting an occurrence of a saturation condition at the output of the TIA (used to implement the BBF) within the RX chain. As described below, in certain aspects, the RxAGC algorithm may employ a trained neural network to determine the occurrence of the saturation condition or use one or more saturation detection circuits coupled to the RX chain to determine the occurrence of the saturation condition.

The apparatus and techniques for performing AGC in wireless receive front-end circuitry may provide various technical advantages. For example, controlling the combined gain of the amplifier(s) within the RX chain of the wireless device based on the new gain state G0′, which has a higher gain and lower NF than the default gain state G0, may improve the reference sensitivity of the wireless receiver, relative to conventional RxAGC algorithms. Consequently, by using the RxAGC algorithm described herein, the performance of wireless receivers (relative to conventional RxAGC algorithms) may be significantly improved in terms of higher throughput, reduced latency, and higher transmission range, as illustrative, non-limiting examples.

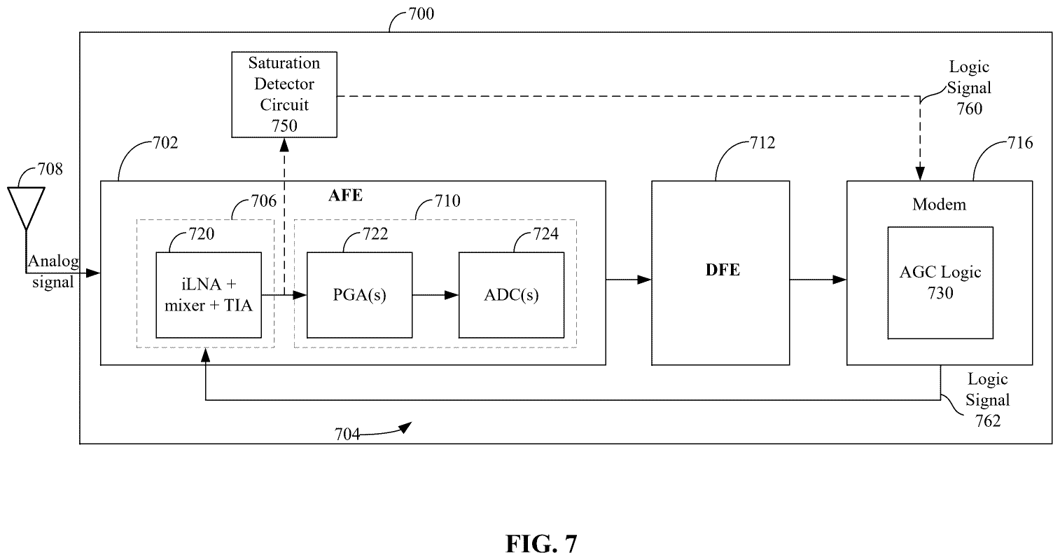

FIG. 7 illustrates an example apparatus 700 for performing RxAGC for a wireless RX path 704, according to certain aspects of the present disclosure. As shown, the apparatus 700 includes the wireless RX path 704, which includes an analog front end (AFE) 702, a digital front end (DFE) 712 (also referred to as a digital RxFE), and a modem 716. The apparatus 700 may be an illustrative implementation of a wireless device, such as UE 120 and BS 110, as illustrative examples. The RX path 704 may be an illustrative implementation of the RX path 304 illustrated in FIG. 3.

As shown, the apparatus 700 includes an antenna 708, which may be used to receive one or more analog signals (including one or more jamming signals). After being received, the one or more analog signals may be provided to the AFE 702 for processing. As shown, the AFE 702 includes a portion 706 and a portion 710. The portion 706 may include an iLNA (e.g., LNA 324), mixer (e.g., mixer 326), and TIA (e.g., BBF 340 implemented with a TIA) (collectively shown as module 720). The portion 710 may include one or more PGA(s) 722 (e.g., similar to PGA 342) and one or more ADC(s) 724 (e.g., similar to ADC 330). The AFE 702 may output a digital reception signal(s) and provide the digital reception signal(s) to the DFE 712 for further processing before being provided to the modem 716.

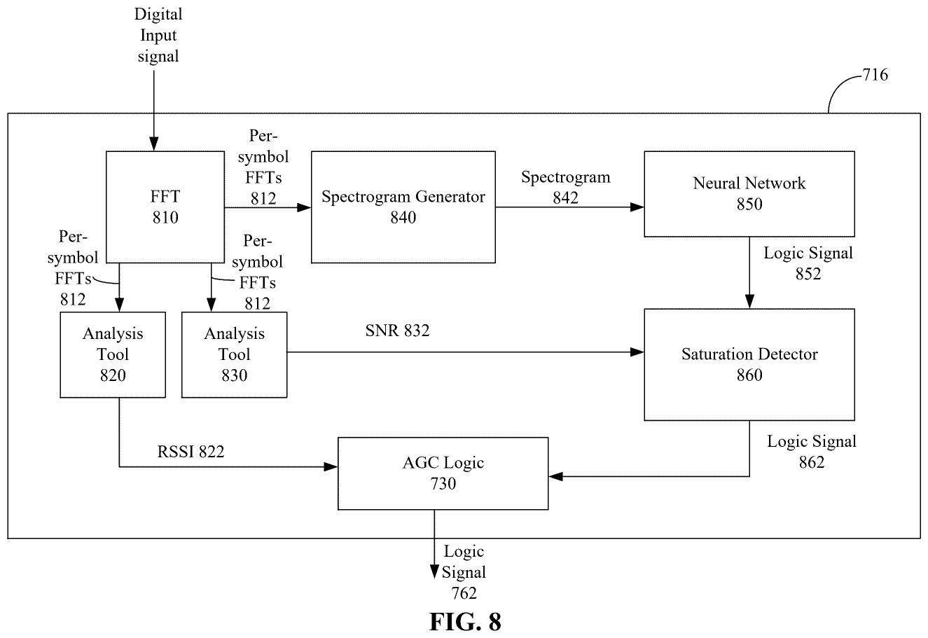

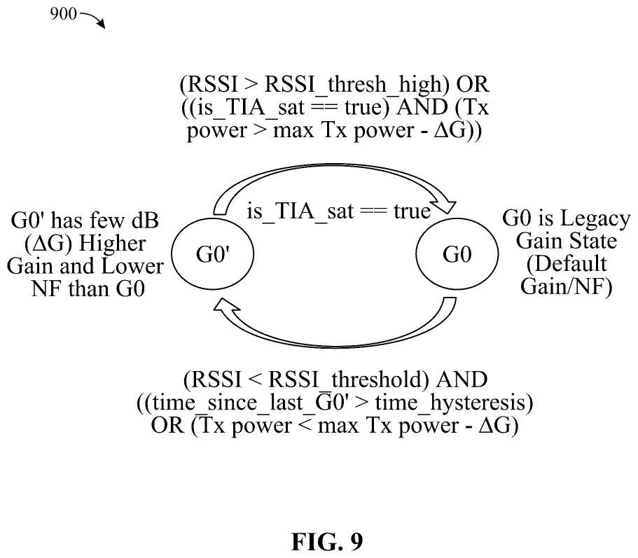

The modem 716 includes AGC logic 730, which is generally configured to control a combined gain of the module 720 using one or more techniques described herein. For example, the AGC logic 730 may select a gain state from a plurality of gain states (including a new gain state G0′ and default gain state G0), and generate a logic signal 762 to trigger a switch in the gain state of the module 720 to the selected gain state. In certain aspects, the AGC logic 730 may trigger a transition from the new gain state G0′ to the default gain state G0 based at least in part on whether there is an occurrence of a saturation condition at the output of the portion 706 of the AFE 702 (or output of the module 720). In some aspects, the AGC logic 730 may determine whether there is an occurrence of a saturation condition based on the digital reception signal(s) input to the modem 716. In other aspects, the AGC logic 730 may determine whether there is an occurrence of a saturation condition via a saturation detector circuit 750 coupled to the output of the module 720. For example, the saturation detector circuit 750 may be configured to monitor the power level of an output signal from the module 720 and to generate a logic signal 760 to indicate saturation when the output signal satisfies a predetermined condition. Note, the AGC logic 730 may be included within the controller 336 and is described in greater detail below with respect to FIGS. 8-9.

Note that FIG. 7 depicts an illustrative example of an apparatus for performing RxAGC for a wireless RX path 704, and that the apparatus for performing RxAGC may have different configurations consistent with the functionality described herein. The saturation detector circuit 750 may be implemented with a power detector circuit (e.g., diode, resistor, capacitor, among other components) and a comparator. For example, the power detector circuit may be configured to determine a power level of the output signal from the module 720, and the comparator may be configured to compare the power level of the output signal to a threshold and to output the logic signal 760, based on the comparison.

FIG. 8 further illustrates the modem 716 of the apparatus 700 illustrated in FIG. 7, according to certain aspects of the present disclosure. As shown, the modem 716 includes, without limitation, a fast Fourier transform (FFT) component 810, an analysis tool 820, and analysis tool 830, a spectrogram generator 840, a neural network 850, a saturation detector 860, and AGC logic 730. In certain aspects, the spectrogram generator 840, the neural network 850, and the saturation detector 860 may operate when the gain state is the new gain state G0′; otherwise, the spectrogram generator 840, the neural network 850, and the saturation detector 860 may be inactive.

The FFT component 810 may receive a digital input signal (e.g., output from the DFE 712), compute a per-symbol FFT 812 of the digital input signal, and provide the per symbol FFTs 812 to the spectrogram generator 840, the analysis tool 820, and the analysis tool 830. The spectrogram generator 840 may generate a spectrogram 842 of a portion of a frequency content of the digital input signal, based on the per-symbol FFTs 812 (e.g., N per-symbol FFTs). In certain aspects, generating the spectrogram 842 may involve performing a convolution of the per-symbol FFTs 812 with an FFT of a predefined windowing function (e.g., a Hanning windowing function or some other windowing function), and computing the per-symbol absolute value squared of the convolved output. Note, in some cases, performing a convolution with the FFT of the windowing function may be optional and may allow for using a non-rectangular window for the spectrogram calculation.

The analysis tool 820 is configured to generate a signal strength metric for the digital input signal, based on the per-symbol FFTs 812. For example, the analysis tool 820 may compute a received signal strength indication (RSSI) 822 for the digital input signal, and provide an indication of the RSSI 822 to the AGC logic 730. The analysis tool 830 is configured to generate another signal strength metric for the digital input signal, based on the per-symbol FFTs 812. For example, the analysis tool 830 may compute a signal-to-noise ratio (SNR) 832 for the digital input signal, and provide an indication of the SNR 832 to the saturation detector 860.

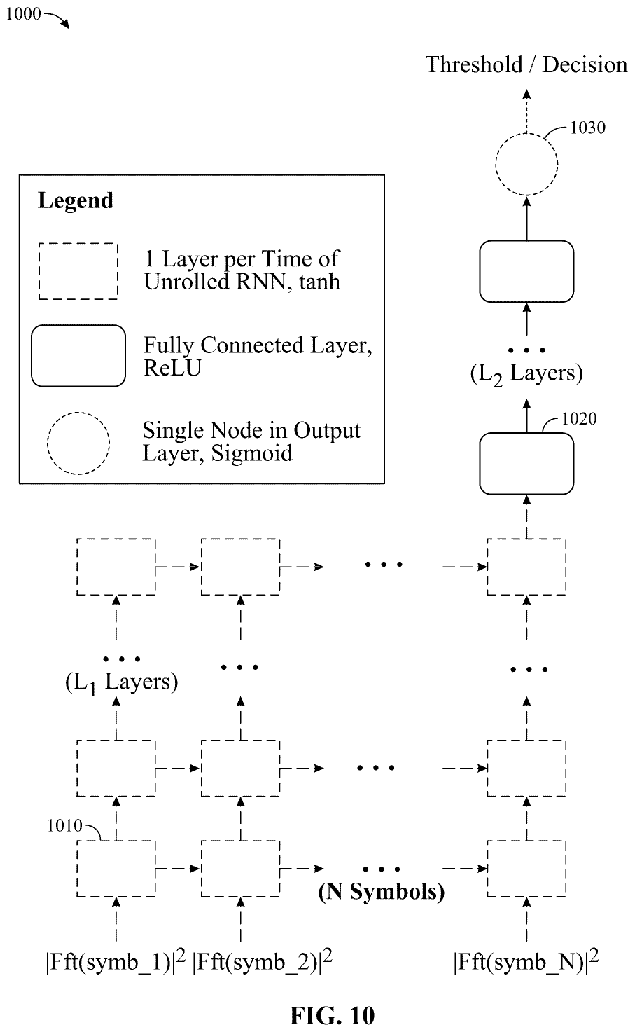

In some cases, the sampling rate at the digital input to the modem 716 may be slightly higher than the bandwidth of the receive (RX) signal. In such cases, a large portion of the interfering TX leakage may be filtered out, such that measurement of the power of samples of the input to the modem 716 may not contain any information about saturation at the output of the module 720. Accordingly, in certain aspects, the neural network 850 may be trained to detect an occurrence of a saturation condition at the output of the module 720, based on evaluating or probing the digital input to the modem 716. That is, rather than measuring power of samples at the input to the modem 716, the neural network 850 may evaluate one or more signatures of saturation occurring upstream in the RX chain that may be embedded within the RX signal and still be present in the digital signal at the input to the modem 716. In such aspects, the saturation condition may include an amount of saturation at the output of the module 720 being greater than a threshold, which may be zero or greater than zero. Here, the neural network 850 may obtain the spectrogram 842 output (N FFTs) from the spectrogram generator 840 as an input, and generate a logic signal 852 indicating whether there is an occurrence of a saturation condition at the output of the module 720. For example, the logic signal 852 may have a value of “1” to indicate the saturation condition has been detected and may have a value of “0” to indicate the saturation condition has not been detected. The neural network 850 can be run with a periodicity of M slots. Note, the neural network 850 is described in greater detail below with respect to FIG. 10.

The saturation detector 860 is generally configured to obtain an indication of the logic signal 852 and the SNR 832, and to generate a logic signal 862 indicating whether there is an occurrence of a saturation condition at the output of the module 720, based on the logic signal 852, the SNR 832, or a combination thereof. For example, in some cases, the saturation detector 860 may determine there is an occurrence of a saturation condition when (i) the logic signal 852 indicates saturation or (ii) when the logic signal 852 does not indicate saturation and the SNR 832 is lower than a threshold. In some cases, the saturation detector 860 may determine there is no occurrence of a saturation condition when (i) the logic signal 852 indicates no saturation and (ii) the SNR 832 is greater than or equal to another threshold. In some cases, the saturation detector 860 may use the SNR 832 as an additional input in scenarios where the dominant distortion in the analog reception signal is from a Tx IM2 as opposed to from TIA saturation.

The AGC logic 730 may obtain the logic signal 862 and the RSSI 822, and generate a logic signal 762 to control a gain state of the module 720 based on the logic signal 862, the RSSI 822, or a combination thereof. By way of example, FIG. 9 is a state diagram 900 for controlling a gain state of the module 720, according to certain aspects of the present disclosure. The state diagram 900 may be performed by the AGC logic 730. As shown, the state diagram 900 includes a default gain state G0 and a new gain state G0′,which has a higher gain and lower NF than the default gain state G0. In certain aspects, the AGC logic 730 may generate the logic signal 762 to trigger a transition from the new gain state G0′ to the default gain state G0 when (i) the RSSI 822 is greater than RSS_thresh_high or (ii) the logic signal 862 indicates occurrence of the saturation condition and a transmit power of the wireless device is greater than a threshold set to a maximum transmission power minus the delta in gain between the new gain state G0′ and the default gain state G0 (e.g., threshold=max Tx power−ΔG). In certain aspects, the AGC logic 730 may generate the logic signal 762 to trigger a transition from the default gain state G0 to the new gain state G0′ when (i) the RSSI 822 is less than RSSI_threshold and (ii) an amount of time that has elapsed since the gain state was the new gain state G0′ is greater than a predefined amount of time or a transmit power of the wireless device is less than a threshold=max Tx power−ΔG.

Referring back to FIG. 8, in certain aspects, when the module 720 is in the new gain state G0′, the AGC logic 730 may be configured to control a distribution of the combined gain to the amplifiers (e.g., LNA 324 and TIA) within module 720, based at least in part on one or more parameters. Such parameters may include a maximum power reduction (MPR) parameter, a W_{gap} parameter, or a combination thereof. In certain aspects, the AGC logic 730 may control the distribution of the combined gain within module 720, such that a higher portion of the combined gain is distributed to the iLNA than the TIA within module 720. In some cases, increasing the iLNA gain as compared to increasing TIA gain may help to reduce the SDR NF, albeit at a potential cost of worsening the TX IM2. In some cases, the AGC logic 730 may distribute a higher portion of the combined gain to the iLNA when MPR≥ΔG which is the delta gain between G0′ and G0. Additionally, for OZIF scenarios with a large W_{gap}, the TX IM2 may not overlap with the RX signal, so the iLNA gain can be increased. If the TX IM2 does overlap with the RX signal and significantly degrades the SNR, the saturation detector 860 may be able to detect this condition and trigger a gain state transition to G0.

FIG. 10 illustrates an example architecture of a neural network 1000, according to certain aspects of the present disclosure. The neural network 1000 may be an illustrative example of the neural network 850 illustrated in FIG. 8. For example, the neural network 1000 may be or include a recurrent neural network (RNN), a variant of an RNN (e.g., a gated recurrent unit (GRU), long short-term memory (LSTM), etc.), a convolutional neural network (CNN), or a variant of a CNN (e.g., AlexNet).

The neural network 1000 may have an input feature dimension=F×N, where F=input feature size per time dimension (e.g., OFDM symbol)=number of FFT bins used in the neural network, and N=#of OFDM symbols used for the spectrogram. The neural network 1000 may have an output feature size=1 (e.g., Boolean). In certain aspects, the input feature dimension (F) may be kept constant for different bandwidths of the input signal (e.g., by padding with zeros for smaller bandwidths and by subsampling the spectrogram in the frequency domain for larger bandwidths).

Here, the neural network 1000 is a many-to-one RNN, which includes a set of L₁ layers 1010, a set of L₂ layers 1020, and an output layer 1030. L₁ layers 1010 may be part of the RNN and L₂ layers 1020 may be fully connected layers. The activation function for the L₁ layers 1010 may be a hyperbolic tangent (tanh) function, the activation function for the L₂ layers 1020 may be a rectified linear unit (ReLU) function, and the activation function for the output layer 1030 may be a sigmoid function. As shown, each L₁ layer 1010 may receive two inputs: one input from the previous L₁ layer 1010, and another input from the previous state of the same layer. Note, however, that these activation functions are merely examples and that other activation functions may be used. For example, in some cases, the activation functions for L₁ layers 1010 and L₂ layers 1020 may be the same. Note that while a certain number of units per L₁ layers 1010 and L₂ layers 1020 are shown, the neural network 1000 may have any number of units per L₁ layer 1010 and L₂ layer 1020.

### Example Operations

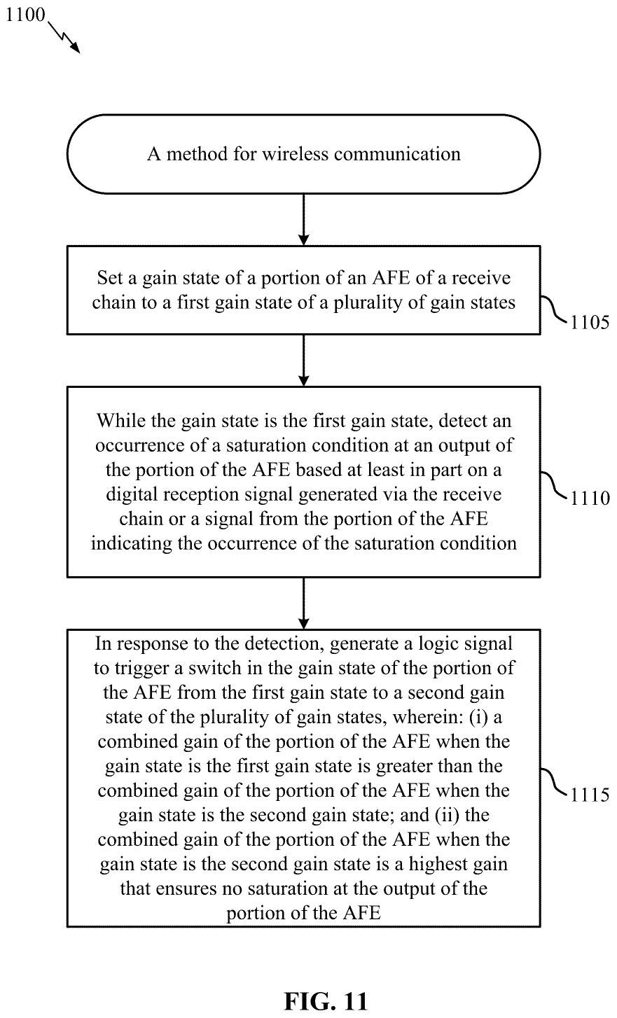

FIG. 11 is a flow diagram of example operations 1100 for wireless communications, in accordance with certain aspects of the present disclosure. The operations 1100 may be used to perform automatic gain control (AGC) for a RX path (e.g., RX path 304, RX path 704, etc.). The operations 800 may be performed, for example, by a controller (e.g., controller 336, modem 716, etc.).

The operations 1100 may generally involve, at block 1105, setting a gain state of a portion (e.g., portion 706) of an analog front end (AFE) (e.g., AFE 702) of a receive chain (e.g., RX path 704) to a first gain state (e.g., G0′) of a plurality of gain states.

The operations 1100 may also involve, at block 1110, while the gain state is the first gain state, detecting an occurrence of a saturation condition at an output of the portion of the AFE based at least in part on a digital reception signal generated via the receive chain or a signal (e.g., logic signal 760) from the portion of the AFE indicating the occurrence of the saturation condition. In certain aspects, the saturation condition may include an amount of saturation at the output of the portion of the AFE being greater than a threshold, which may be zero or greater than zero.

The operations 1100 may further involve, at block 1115, in response to the detection, generating a logic signal (e.g., logic signal 762) to trigger a switch in the gain state of the portion of the AFE from the first gain state to a second gain state (e.g., G0) of the plurality of gain states. A combined gain of the portion of the AFE when the gain state is the first gain state is greater than the combined gain of the portion of the AFE when the gain state is the second gain state. The combined gain of the portion of the AFE when the gain state is the second gain state is a highest gain that ensures no saturation at the output of the portion of the AFE.

In certain aspects, detecting the occurrence of the saturation condition (at block 1115) may involve (i) providing the digital reception signal as an input to a neural network (e.g., neural network 850) trained to detect the occurrence of the saturation condition and (ii) obtaining, from the neural network in response to the digital reception signal, an indication of the occurrence of the saturation condition.

In such aspects, detecting the occurrence of the saturation condition may include generating a spectrogram (e.g., spectrogram 842) of at least a portion of a frequency content of the digital reception signal, and providing the digital reception signal may include providing the spectrogram as the input to the neural network. The neural network may be a RNN, a variant of an RNN, a CNN, or a variant of a CNN.

Additionally, in such aspects, detecting the occurrence of the saturation condition may include: (i) generating an estimate of a signal-to-noise ratio (SNR) (e.g., SNR 832) of the digital reception signal and (ii) detecting the occurrence of the saturation condition further based on the estimate of the SNR.

In certain aspects, the portion of the AFE of the receive chain may include a first amplifier (e.g., LNA 324), a mixer (e.g., mixer 326) having an input coupled to an output of the first amplifier, and a second amplifier (e.g., TIA used to implement a BBF 340) having an input coupled to an output of the mixer. In such aspects, the operations 1100 may further involve, in response to the detection, controlling a distribution of the combined gain to the first amplifier and the second amplifier when the gain state is the first gain state, based at least in part on one or more parameters. The parameters may include a MPR parameter, a W_{gap} parameter, or a combination thereof.

In certain aspects, controlling the distribution of the combined gain may include distributing a higher portion of the combined gain to the first amplifier than the second amplifier when the gain state is the first gain state.

In certain aspects, the operations 1100 may further involve generating the first logic signal to trigger the switch in the gain state from the first gain state to the second gain state when a set of conditions is satisfied. The set of conditions may include at least one of (i) a signal strength of the digital reception signal (e.g., RSSI 822) being greater than a first threshold or (ii) the occurrence of the saturation condition and a transmit power of the apparatus (e.g., apparatus 700) being greater than a second threshold.

In certain aspects, the operations 1100 may further involve generating a second logic signal to trigger a switch in the gain state from the second gain state to the first gain state when a set of conditions is satisfied. The set of conditions may include (i) a signal strength of the digital reception signal (e.g., RSSI 822) being less than a first threshold and (ii) an amount of time that has elapsed since the gain state was the first gain state being greater than a second threshold or a transmit power of the apparatus (e.g., apparatus 700) being less than a third threshold.

In certain aspects, the operations 1100 may further involve generating the signal to indicate the occurrence of the saturation condition via a saturation detector circuit (e.g., saturation detector circuit 750) coupled to an output of the portion of the AFE. For example, the saturation detector circuit may be configured to generate the signal when a power of an output signal from the portion of the AFE is greater than a threshold.

### Example Clauses

Implementation examples are described in the following numbered clauses:
Clause 1: An apparatus for wireless communications, comprising: a receive chain configured to receive an analog reception signal and to process the analog reception signal to generate a digital reception signal; and control logic having an input coupled to an output of the receive chain, the control logic being configured to: set a gain state of a portion of an analog front end (AFE) of the receive chain to a first gain state of a plurality of gain states; while the gain state is the first gain state, detect an occurrence of a saturation condition at an output of the portion of the AFE based at least in part on the digital reception signal or a signal from the portion of the AFE indicating the occurrence of the saturation condition; and in response to the detection, generate a first logic signal to trigger a switch in the gain state of the portion of the AFE from the first gain state to a second gain state of the plurality of gain states, wherein: a combined gain of the portion of the AFE when the gain state is the first gain state is greater than the combined gain of the portion of the AFE when the gain state is the second gain state; and the combined gain of the portion of the AFE when the gain state is the second gain state is a highest gain that ensures no saturation at the output of the portion of the AFE.
Clause 2: The apparatus of Clause 1, wherein to detect the occurrence of the saturation condition, the control logic is configured to: provide the digital reception signal as an input to a neural network trained to detect the occurrence of the saturation condition; and obtain, from the neural network in response to the digital reception signal, an indication of the occurrence of the saturation condition.
Clause 3: The apparatus of Clause 2, wherein: to detect the occurrence of the saturation condition, the control logic is further configured to generate a spectrogram of at least a portion of a frequency content of the digital reception signal; and to provide the digital reception signal as the input to the neural network, the control logic is configured to provide the spectrogram as the input to the neural network.
Clause 4: The apparatus according to any of Clauses 2-3, wherein the neural network is a recurrent neural network (RNN), a variant of an RNN, a convolutional neural network (CNN), or a variant of a CNN.
Clause 5: The apparatus according to any of Clauses 2-4, wherein to detect the occurrence of the saturation condition, the control logic is configured to: generate an estimate of a signal-to-noise ratio (SNR) of the digital reception signal; and detect the occurrence of the saturation condition further based on the estimate of the SNR.
Clause 6: The apparatus according to any of Clauses 1-5, wherein: the portion of the AFE of the receive chain comprises a first amplifier, a mixer having an input coupled to an output of the first amplifier, and a second amplifier having an input coupled to an output of the mixer; and in response to the detection, the control logic is further configured to control a distribution of the combined gain to the first amplifier and the second amplifier when the gain state is the first gain state, based at least in part on one or more parameters.
Clause 7: The apparatus of Clause 6, wherein the one or more parameters comprise a maximum power reduction (MPR) parameter for the apparatus, a gap between a primary component carrier (PCC) and a secondary component carrier (SCC) within a receive frequency band of the receive chain, or a combination thereof.
Clause 8: The apparatus according to any of Clauses 6-7, wherein to control the distribution of the combined gain, the control logic is configured to distribute a higher portion of the combined gain to the first amplifier than the second amplifier when the gain state is the first gain state.
Clause 9: The apparatus according to any of Clauses 1-8, wherein the saturation condition comprises an amount of saturation at the output of the portion of the AFE being greater than a threshold.
Clause 10: The apparatus of Clause 9, wherein the threshold is zero.
Clause 11: The apparatus according to any of Clauses 1-10, wherein: the control logic is configured to generate the first logic signal to trigger the switch in the gain state from the first gain state to the second gain state when a set of conditions is satisfied; and the set of conditions comprises at least one of (i) a signal strength of the digital reception signal being greater than a first threshold or (ii) the occurrence of the saturation condition and a transmit power of the apparatus being greater than a second threshold.
Clause 12: The apparatus according to any of Clauses 1-11, wherein: the control logic is further configured to generate a second logic signal to trigger a switch in the gain state from the second gain state to the first gain state when a set of conditions is satisfied; and the set of conditions comprises (i) a signal strength of the digital reception signal being less than a first threshold and (ii) an amount of time that has elapsed since the gain state was the first gain state being greater than a second threshold or a transmit power of the apparatus being less than a third threshold.
Clause 13: The apparatus according to any of Clauses 1-12, wherein the portion of the AFE of the receive chain comprises a first amplifier, a mixer comprising an input coupled to an output of the first amplifier, and a second amplifier comprising an input coupled to an output of the mixer.
Clause 14: The apparatus of Clause 13, further comprising a saturation detector circuit coupled to an output of the second amplifier, the saturation detector circuit being configured to generate the signal to indicate the occurrence of the saturation condition when a power of an output signal from the second amplifier is greater than a threshold.
Clause 15: A method for wireless communications, the method comprising: setting a gain state of a portion of an analog front end (AFE) of a receive chain to a first gain state of a plurality of gain states; while the gain state is the first gain state, detecting an occurrence of a saturation condition at an output of the portion of the AFE based at least in part on a digital reception signal generated via the receive chain or a signal from the portion of the AFE indicating the occurrence of the saturation condition; and in response to the detection, generating a logic signal to trigger a switch in the gain state of the portion of the AFE from the first gain state to a second gain state of the plurality of gain states, wherein: a combined gain of the portion of the AFE when the gain state is the first gain state is greater than the combined gain of the portion of the AFE when the gain state is the second gain state; and the combined gain of the portion of the AFE when the gain state is the second gain state is a highest gain that ensures no saturation at the output of the portion of the AFE.
Clause 16: The method of Clause 15, wherein detecting the occurrence of the saturation condition comprises: providing the digital reception signal as an input to a neural network trained to detect the occurrence of the saturation condition; and obtaining, from the neural network in response to the digital reception signal, an indication of the occurrence of the saturation condition.
Clause 17: The method of Clause 16, wherein: detecting the occurrence of the saturation condition further comprises generating a spectrogram of at least a portion of a frequency content of the digital reception signal; and providing the digital reception signal comprises providing the spectrogram as the input to the neural network.
Clause 18: The method according to any of Clauses 16-17, wherein detecting the occurrence of the saturation condition comprises: generating an estimate of a signal-to-noise ratio (SNR) of the digital reception signal; and detecting the occurrence of the saturation condition further based on the estimate of the SNR.
Clause 19: The method according to any of Clauses 15-18, wherein: the portion of the AFE of the receive chain comprises a first amplifier, a mixer having an input coupled to an output of the first amplifier, and a second amplifier having an input coupled to an output of the mixer; and the method further comprises, in response to the detection, controlling a distribution of the combined gain to the first amplifier and the second amplifier when the gain state is the first gain state, based at least in part on one or more parameters.
Clause 20: A wireless device comprising: an antenna; a receive chain coupled to the antenna, the receive chain being configured to receive an analog reception signal via the antenna and to process the analog reception signal to generate a digital reception signal; and control logic having an input coupled to an output of the receive chain, the control logic being configured to: set a gain state of a portion of an analog front end (AFE) of the receive chain to a first gain state of a plurality of gain states; while the gain state is the first gain state, detect an occurrence of a saturation condition at an output of the portion of the AFE based at least in part on the digital reception signal or a signal from the portion of the AFE indicating the occurrence of the saturation condition; and in response to the detection, generate a logic signal to trigger a switch in the gain state of the portion of the AFE from the first gain state to a second gain state of the plurality of gain states, wherein: a combined gain of the portion of the AFE when the gain state is the first gain state is greater than the combined gain of the portion of the AFE when the gain state is the second gain state; and the combined gain of the portion of the AFE when the gain state is the second gain state is a highest gain that ensures no saturation at the output of the portion of the AFE.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
a receive chain configured to receive an analog reception signal and to process the analog reception signal to generate a digital reception signal; and
control logic having an input coupled to an output of the receive chain, the control logic being configured to:
set a gain state of a portion of an analog front end (AFE) of the receive chain to a first gain state of a plurality of gain states;
while the gain state is the first gain state, detect an occurrence of a saturation condition at an output of the portion of the AFE based at least in part on the digital reception signal or a signal from the portion of the AFE indicating the occurrence of the saturation condition; and
in response to the detection, generate a first logic signal to trigger a switch in the gain state of the portion of the AFE from the first gain state to a second gain state of the plurality of gain states, wherein:
a combined gain of the portion of the AFE when the gain state is the first gain state is greater than the combined gain of the portion of the AFE when the gain state is the second gain state; and
the combined gain of the portion of the AFE when the gain state is the second gain state is a highest gain that ensures no saturation at the output of the portion of the AFE.

2. The apparatus of claim 1, wherein to detect the occurrence of the saturation condition, the control logic is configured to:
provide the digital reception signal as an input to a neural network trained to detect the occurrence of the saturation condition; and
obtain, from the neural network in response to the digital reception signal, an indication of the occurrence of the saturation condition.

3. The apparatus of claim 2, wherein:
to detect the occurrence of the saturation condition, the control logic is further configured to generate a spectrogram of at least a portion of a frequency content of the digital reception signal; and
to provide the digital reception signal as the input to the neural network, the control logic is configured to provide the spectrogram as the input to the neural network.

4. The apparatus of claim 2, wherein the neural network is a recurrent neural network (RNN), a variant of an RNN, a convolutional neural network (CNN), or a variant of a CNN.

5. The apparatus of claim 2, wherein to detect the occurrence of the saturation condition, the control logic is configured to:
generate an estimate of a signal-to-noise ratio (SNR) of the digital reception signal; and
detect the occurrence of the saturation condition further based on the estimate of the SNR.

6. The apparatus of claim 1, wherein:
the portion of the AFE of the receive chain comprises a first amplifier, a mixer having an input coupled to an output of the first amplifier, and a second amplifier having an input coupled to an output of the mixer; and
in response to the detection, the control logic is further configured to control a distribution of the combined gain to the first amplifier and the second amplifier when the gain state is the first gain state, based at least in part on one or more parameters.

7. The apparatus of claim 6, wherein the one or more parameters comprise a maximum power reduction (MPR) parameter for the apparatus, a gap between a primary component carrier (PCC) and a secondary component carrier (SCC) within a receive frequency band of the receive chain, or a combination thereof.

8. The apparatus of claim 6, wherein to control the distribution of the combined gain, the control logic is configured to distribute a higher portion of the combined gain to the first amplifier than the second amplifier when the gain state is the first gain state.

9. The apparatus of claim 1, wherein the saturation condition comprises an amount of saturation at the output of the portion of the AFE being greater than a threshold.

10. The apparatus of claim 9, wherein the threshold is zero.

11. The apparatus of claim 1, wherein:
the control logic is configured to generate the first logic signal to trigger the switch in the gain state from the first gain state to the second gain state when a set of conditions is satisfied; and
the set of conditions comprises at least one of (i) a signal strength of the digital reception signal being greater than a first threshold or (ii) the occurrence of the saturation condition and a transmit power of the apparatus being greater than a second threshold.

12. The apparatus of claim 1, wherein:
the control logic is further configured to generate a second logic signal to trigger a switch in the gain state from the second gain state to the first gain state when a set of conditions is satisfied; and
the set of conditions comprises (i) a signal strength of the digital reception signal being less than a first threshold and (ii) an amount of time that has elapsed since the gain state was the first gain state being greater than a second threshold or a transmit power of the apparatus being less than a third threshold.

13. The apparatus of claim 1, wherein the portion of the AFE of the receive chain comprises a first amplifier, a mixer comprising an input coupled to an output of the first amplifier, and a second amplifier comprising an input coupled to an output of the mixer.

14. The apparatus of claim 13, further comprising a saturation detector circuit coupled to an output of the second amplifier, the saturation detector circuit being configured to generate the signal to indicate the occurrence of the saturation condition when a power of an output signal from the second amplifier is greater than a threshold.

15. A method for wireless communications, the method comprising:
setting a gain state of a portion of an analog front end (AFE) of a receive chain to a first gain state of a plurality of gain states;
while the gain state is the first gain state, detecting an occurrence of a saturation condition at an output of the portion of the AFE based at least in part on a digital reception signal generated via the receive chain or a signal from the portion of the AFE indicating the occurrence of the saturation condition; and
in response to the detection, generating a logic signal to trigger a switch in the gain state of the portion of the AFE from the first gain state to a second gain state of the plurality of gain states, wherein:
a combined gain of the portion of the AFE when the gain state is the first gain state is greater than the combined gain of the portion of the AFE when the gain state is the second gain state; and
the combined gain of the portion of the AFE when the gain state is the second gain state is a highest gain that ensures no saturation at the output of the portion of the AFE.

16. The method of claim 15, wherein detecting the occurrence of the saturation condition comprises:
providing the digital reception signal as an input to a neural network trained to detect the occurrence of the saturation condition; and
obtaining, from the neural network in response to the digital reception signal, an indication of the occurrence of the saturation condition.

17. The method of claim 16, wherein:
detecting the occurrence of the saturation condition further comprises generating a spectrogram of at least a portion of a frequency content of the digital reception signal; and
providing the digital reception signal comprises providing the spectrogram as the input to the neural network.

18. The method of claim 16, wherein detecting the occurrence of the saturation condition comprises:
generating an estimate of a signal-to-noise ratio (SNR) of the digital reception signal; and
detecting the occurrence of the saturation condition further based on the estimate of the SNR.

19. The method of claim 15, wherein:
the portion of the AFE of the receive chain comprises a first amplifier, a mixer having an input coupled to an output of the first amplifier, and a second amplifier having an input coupled to an output of the mixer; and
the method further comprises, in response to the detection, controlling a distribution of the combined gain to the first amplifier and the second amplifier when the gain state is the first gain state, based at least in part on one or more parameters.

20. A wireless device comprising:
an antenna;
a receive chain coupled to the antenna, the receive chain being configured to receive an analog reception signal via the antenna and to process the analog reception signal to generate a digital reception signal; and
control logic having an input coupled to an output of the receive chain, the control logic being configured to:
set a gain state of a portion of an analog front end (AFE) of the receive chain to a first gain state of a plurality of gain states;
while the gain state is the first gain state, detect an occurrence of a saturation condition at an output of the portion of the AFE based at least in part on the digital reception signal or a signal from the portion of the AFE indicating the occurrence of the saturation condition; and
in response to the detection, generate a logic signal to trigger a switch in the gain state of the portion of the AFE from the first gain state to a second gain state of the plurality of gain states, wherein:
a combined gain of the portion of the AFE when the gain state is the first gain state is greater than the combined gain of the portion of the AFE when the gain state is the second gain state; and
the combined gain of the portion of the AFE when the gain state is the second gain state is a highest gain that ensures no saturation at the output of the portion of the AFE.
